(19) United States
(12) Patent Application Publication
(10) Pub. No.: US 2012/0114829 A1
(43) Pub. Date: May 10, 2012

(54) FEED BLOCK COMPOSITION

(75) Inventor: Graeme Freemantle, Victoria (AU)

(73) Assignee: FREESTOCK PTY LTD, Eddington VIC (AU)

(21) Appl. No.: 13/263,720

(22) PCT Filed: Apr. 8, 2010
(86) PCT No.: PCT/AU2010/000395

§ 371 Date: Dec. 20, 2011

(30) Foreign Application Priority Data
Apr. 9, 2009 (AU) 2009901560

(51) Int. Cl. A23K 1/14; A23K 1/02; A23P 1/00

(52) U.S. Cl. 426/623; 426/635; 426/658; 426/636; 426/630; 426/512

(57) ABSTRACT

The present invention relates to an animal feed composition including: (a) 30-98 wt % of vegetable matter; (b) 1-60 wt % of a carbohydrate source; and (c) 1-20 wt % of an inorganic binding agent.

### FIELD OF THE INVENTION

The present invention relates to animal feed compositions. In particular, the present invention relates to animal feed compositions which can be prepared in compressed block form and methods of making compressed block animal feed compositions.

### BACKGROUND TO THE INVENTION

Compressed forms of animal feed are an important source of food for livestock. Such forms are of particular importance in dry or arid areas where natural supplies of food frequently need to be supplemented with additional feed sources. Compressed forms of animal feed also become important during times of drought, or where food needs to be delivered to livestock in an urban or semi-urban environment. Feed blocks offer the particular advantage of being relatively easy to store and transport. Feed blocks are also able to be distributed in a pasture or paddock with relative ease, either manually or via an automated device.

In some instances feed blocks are prepared by mixing two or more premixes and allowing them to set in an appropriate mold over a period of time. In such cases hard blocks are typically formed on the time scale of hours. A variety of additives can be optionally incorporated into such feed blocks, with the blocks subsequently useful as animal feed supplements rather than feed per se. Typical additives include minerals, non-protein nitrogen, salt, vitamins and medicines.

There is a need for a feed block which is comprised predominantly of vegetable matter material and to which can be added nutrients and supplements as required. Moreover, there remains a further need for a process for preparing stable feed blocks which incorporate predominantly vegetable matter.

The discussion of the background to the invention herein is included to explain the context of the invention. This is not to be taken as an admission that any of the material referred to was published, known or part of the common general knowledge as at the priority date of any of the claims.

### SUMMARY OF THE INVENTION

In one aspect, the present invention provides an animal feed composition including: (i) 30-98 wt % of vegetable matter; (ii) 1-60 wt % of a carbohydrate source; and (iii) 1-20 wt% of an inorganic binding agent. In some particular embodiments the animal feed compositions of the invention include 1-10 wt % of the inorganic binding agent. In some other embodiments the animal feed compositions of the invention include 1-5 wt % of the inorganic binding agent.

In some embodiments of the compositions of the invention, the carbohydrate source is molasses. In some embodiments of the compositions of the invention, the inorganic binding agent is hydrated lime. In some particular compositions of the invention, the carbohydrate source is molasses and the inorganic binding agent is hydrated lime.

In some embodiments the animal feed composition of the invention is in a compressed form. In some particular embodiments the compressed form is a block.

In some embodiments of the animal feed composition of the invention, the vegetable matter is selected from the group consisting of chaff, grains, hays, cereals, straws, legumes, and mixtures thereof. In some particular embodiments the vegetable matter is selected from the group consisting of lucerne chaff, lucerne hay, oaten chaff, oaten hay, black sunflower seeds, feed oats, maize, lupins, tic beans, barley, rice, wheat, sorghum, and mixtures thereof.

In a second aspect, the present invention provides a process for preparing a compressed block animal feed composition including:

providing vegetable matter, a carbohydrate source and an inorganic binding agent; mixing the vegetable matter, carbohydrate source and inorganic binding agent to provide a mixture thereof; and applying pressure to the mixture to form a compressed block of the mixture.

In some embodiments of the invention the applied pressure is in the range of 25-500 tonne.

In some embodiments of the process of the invention, mixing the vegetable matter, carbohydrate source and inorganic binding agent includes:

adding the vegetable matter to the carbohydrate source and mixing for a first period of time;

adding the inorganic binding agent to the vegetable matter and carbohydrate source and mixing for a second period of time.

In other embodiments of the process of the invention, mixing the vegetable matter, carbohydrate source and inorganic binding agent includes: adding a first portion of the vegetable matter to the carbohydrate source and mixing for a first period of time;

adding a second portion of the vegetable matter to the first portion of vegetable matter and the carbohydrate source and mixing for a second period of time;
adding the inorganic binding agent to the first and second portions of vegetable matter and carbohydrate source and mixing for a third period of time.

In still other embodiments of the process of the invention mixing the vegetable matter, carbohydrate source and inorganic binding agent includes: adding a first portion of the vegetable matter to the carbohydrate source and mixing for a first period of time;

adding a second portion of the vegetable matter to the first portion of vegetable matter and the carbohydrate source and mixing for a second period of time;

adding a third portion of the vegetable matter to the first and second portions of vegetable matter and the carbohydrate source and mixing for a third period of time;

adding the inorganic binding agent to the first, second and third portions of vegetable matter and carbohydrate source and mixing for a fourth period of time.

In some embodiments of the process of the invention, the carbohydrate source is molasses. In some embodiments of the process of the invention, the inorganic binding agent is hydrated lime. In some particular processes of the invention, the carbohydrate source is molasses and the inorganic binding agent is hydrated lime.

In some embodiments of the process of the invention, the vegetable matter is selected from the group consisting of chaff, grains, hays, cereals, straws, legumes, and mixtures thereof. In some particular embodiments the vegetable matter is selected from the group consisting of lucerne chaff, lucerne hay, oaten chaff, oaten hay, black sunflower seeds, feed oats, maize, lupins, tic beans, barley, rice, wheat, sorghum, and mixtures thereof.

In embodiments where the vegetable matter is added in portions, the portions may be the same or different. In embodiments where the vegetable matter is added in first and second portions, the first portion may be a grain or selected from the group consisting of black sunflower seeds, feed oats, maize, lupins, tic beans, barley, rice, wheat, sorghum, and mixtures thereof. The second portion may be chaff or hay, or a mixture thereof. In some specific embodiments the second portion may be selected from the group consisting of oaten chaff, oaten hay, lucerne chaff and lucerne hay, and mixtures thereof.

In embodiments where the vegetable matter is added in first, second and third portions, the first portion may be a grain or selected from the group consisting of black sunflower seeds, feed oats, maize, lupins, tic beans, barley, rice, wheat, sorghum, and mixtures thereof. The second portion may be chaff or hay, or a mixture thereof. In some specific embodiments the second portion may be selected from the group consisting of oaten chaff and oaten hay, and mixtures thereof. The third portion may be chaff or hay, or a mixture thereof. In some specific embodiments the third portion may be selected from the group consisting of lucerne chaff, lucerne hay, and mixtures thereof.

### DETAILED DESCRIPTION OF THE INVENTION

Animal feed compositions of the present invention typically include vegetable matter, a carbohydrate source; and an inorganic binding agent. The vegetable matter is typically present in a proportion of 30-98 wt %, and in particular cases may be present in a proportion of 75 to 95 wt % or 80 to 90 wt %. The vegetable matter typically includes chaff, grains, hays, cereals, straws, legumes, or mixtures thereof. Examples of vegetable matter suitable for use with the invention include lucerne chaff, lucerne hay, oaten chaff, oaten hay, black sunflower seeds, feed oats, maize, lupins, tic beans, barley, rice, wheat, sorghum, or mixtures thereof, though any plant derived material suitable for feeding animals will be appropriate for use with the invention. This may also extend to fruit, vegetable and seed. Wherein mixtures of vegetable matter are used the proportions may be varied in order to meet the nutritional requirements of the particular animals being fed.

In some cases the vegetable matter is crushed prior to incorporation into the compositions of the invention. This crushing may be done by any means known to one skilled in the art, and may be performed so as to provide a more even texture to the composition or to make further handling of the composition easier. In other cases the vegetable matter is processed prior to incorporation in the compositions. Said processing may involve the addition of certain additives such as vitamins, minerals, preservatives, supplements or flavourings, or may involve milling or other processing so as to achieve a particular size distribution of the vegetable matter prior to incorporation into the animal feed compositions of the invention. In other cases the vegetable matter used in compositions of the invention is whole. This is particularly so when the vegetable matter has a relatively small particle size such as a grain or vegetable matter like black sunflower seeds, feed oats, maize, lupins, tic beans, barley, rice, wheat or sorghum.

Carbohydrate sources suitable for incorporation into the composition are typically added in a proportion of 1-60 wt %. In particular cases, the carbohydrate source may be present in the composition in a proportion of 5-20 wt %. In some cases the carbohydrate source is added such that the proportion of carbohydrate source is 7 to 15 wt %. The carbohydrate source is typically a carbohydrate syrup such as corn syrup, glucose syrup, sugar syrup, golden syrup, treacle or molasses, or a mixture thereof. In particular embodiments of the invention molasses is used as the carbohydrate source.

Inorganic binding agents suitable for use with the invention may be any inorganic binding agent which, when combined with the vegetable matter and carbohydrate source will provide a suitably firm composition. The inorganic binding agent will typically be non-toxic to the animals to be fed. The inorganic binding agent will typically be a compound of an alkali earth metal such as barium, calcium, magnesium or strontium. More preferably, the inorganic binding agent will be a compound of calcium or magnesium, and most preferably a compound of calcium. Inorganic binding agents which may be suitable for use with the invention include gypsum, calcium silicate, calcium sulfate, hydrated lime, talc, dolomite, serpentine or magnesium hydroxide. The inorganic binding agent is typically present in an amount of from 1-20 wt %, more typically from 1-10%. In some embodiments inorganic binding agent is present in an amount of from 1-5 wt %. The amount of inorganic binding agent can be varied depending on the particular inorganic binding agent added and the desired properties of the composition. A particularly favored inorganic binding agent is hydrated lime. A particularly favoured amount of hydrated lime is 1-20 wt %. In some other embodiments the amount of hydrated lime is 1-10 wt %. In still other embodiments, the amount of hydrated lime is 1-5 wt %.

The animal feed composition of the invention may be compressed to form blocks of animal feed composition. The compression may be performed using any means known to one having skill in the art of feed block formation, but is typically performed by charging a compressing unit with the a mixture of the vegetable matter, carbohydrate source and inorganic binding agent and then applying pressure such that the composition is formed into a block. The block may be any size and shape, and will typically be determined by the size and shape of the chamber in the compressing unit. A typical size range for compressed blocks of the invention is between 0.5 kg and 100 kg, more typically between 2 and 50 kg and even more typically between 3 and 20 kg. The blocks formed are typically substantially cubical or substantially rectangularly prismatic. Pressure is typically applied at a level of between 25 and 500 tonne in order to press the composition into suitably stable blocks. In some cases pressure is applied at a level between 50 and 250 tonne. In still other cases pressure is applied at a level between 100 and 200 tonne. Compression takes place for any length of time suitable for forming the blocks as would be appreciated by one having skill in the art. Typical compression times are in the order of 5 s to 1 minute. In other cases pressure may be applied for between 10 s and 45 s. In still other cases pressure may be applied for between 15 and 30 s.

Additional materials may also be added to animal feed compositions of the invention. The particular additional materials added will be determined by the particular animals to be fed with the composition, and in particular the nutritional and dietary requirements of those animals. The materials added may be incorporated as vitamins, minerals, preservatives, supplements or flavourings. Examples of possible additives include protein meals such as Protexin, feed grade oils such as vegetable, sunflower or canola oil, trace element, vitamin or mineral products such as zeolite, V&M or kiln dried fine salt. In some cases the additives may be by-products from the production of human or animal foodstuffs. In other cases the additives may be custom made veterinary products known to those having skill in the art.

The process for preparing a compressed block of animal feed composition in accord with the invention typically includes the following aspects: providing vegetable matter, carbohydrate source and inorganic binding agent; mixing the vegetable matter, carbohydrate source and inorganic binding agent to provide a mixture including vegetable matter, carbohydrate source and inorganic binding agent; and applying pressure to the mixture to form a compressed block of the mixture. The pressure applied is typically in the range of 25 to 500 tonne, though other pressures may be used without departing from the scope of the present invention. The applied pressure will be determined by a number of factors, including the particular vegetable matter, carbohydrate source and inorganic binding agent used in the process.

The process of mixing the vegetable matter, carbohydrate source and inorganic binding agent may be performed in a number of steps. For instance, the process of mixing the vegetable matter, carbohydrate source and inorganic binding agent may include adding the vegetable matter to the carbohydrate source and mixing for a first period of time, followed by adding the inorganic binding agent to the vegetable matter and carbohydrate source and mixing for a second period of time. The first period of time may be any time suitable for effectively mixing the vegetable matter and the carbohydrate source. The first period of time is typically between 1 minute and 20 minutes, and more typically between 5 minutes and 15 minutes. Likewise, the second period of time may be any length of time sufficient for effectively mixing the inorganic binding agent to the vegetable matter and carbohydrate source. The second period of time is typically between 1 minute and 20 minutes, and more typically between 5 minutes and 15 minutes. The vegetable matter added to the carbohydrate source typically includes chaff, grains, hays, cereals, straws, legumes, or mixtures thereof. Examples of vegetable matter added to the carbohydrate source are lucerne chaff, lucerne hay, oaten chaff, oaten hay, black sunflower seeds, feed oats, maize, lupins, tic beans, barley, rice, wheat, sorghum, or mixtures thereof.

The process of mixing the vegetable matter, carbohydrate source and inorganic binding agent may also be performed by adding the plant derived feed material in two discrete additions. That is the process of mixing the vegetable matter, carbohydrate source and inorganic binding agent may include: adding a first portion of the vegetable matter to the carbohydrate source and mixing for a first period of time; adding a second portion of the vegetable matter to the first portion of vegetable matter and the carbohydrate source and mixing for a second period of time; and adding the inorganic binding agent to the first and second portions of vegetable matter and carbohydrate source and mixing for a third period of time. The first portion of vegetable matter may be a grain or may be selected from the group consisting of black sunflower seeds, feed oats, maize, lupins, tic beans, barley, rice, wheat, sorghum, and mixtures thereof. The second portion of vegetable matter may be a chaff or a hay, or a mixture thereof. For instance, the second portion of vegetable matter may include lucerne chaff, lucerne hay, oaten chaff, oaten hay, or mixtures thereof. The first period of time may be any length of time suitable for sufficiently blending the first portion of vegetable matter with the carbohydrate source. Such a time period is typically between 1 minute and 20 minutes, and even more typically between 5 minutes and 15 minutes. Likewise, the second period of time may be any length of time suitable for sufficiently blending the second portion of vegetable matter with the first portion of vegetable matter and carbohydrate source. Such a time period is typically between 1 minute and 20 minutes, and even more typically between 5 minutes and 15 minutes. The third period of time may be any length of time suitable for sufficiently blending the inorganic binding agent with the first and second portions of vegetable matter and the carbohydrate source. Such a time period is typically between 1 minute and 20 minutes, and even more typically between 5 minutes and 15 minutes.

The process of mixing may result in a reduction in the particle size of the vegetable matter relative to the particle size before the mixing process. This is particularly relevant when the vegetable matter is chaff or hay. The reduction in size can be controlled by variation of factors such as the mixing speed, mixing time and relative proportions of various ingredients. Typically the final particle size achieved by the process of mixing is between 1 and 200 mm.

The process of mixing the vegetable matter, carbohydrate source and inorganic binding agent may also be performed by adding the plant derived feed material in three discrete additions. In this case mixing the vegetable matter, carbohydrate source and inorganic binding agent may include adding a first portion of the vegetable matter to the carbohydrate source and mixing for a first period of time; adding a second portion of the vegetable matter to the first portion of vegetable matter and the carbohydrate source and mixing for a second period of time; adding a third portion of the vegetable matter to the first and second portions of vegetable matter and the carbohydrate source and mixing for a third period of time; and adding the inorganic binding agent to the first, second and third portions of vegetable matter and carbohydrate source and mixing for a fourth period of time. The first portion of vegetable matter may be a grain or may be selected from the group consisting of black sunflower seeds, feed oats, maize, lupins, tic beans, barley, rice, wheat, sorghum, and mixtures thereof. The second portion may the same or different to the first portion of vegetable matter. In some cases, the second portion of vegetable matter may be a chaff or a hay, or a mixture thereof. For instance, the second portion of vegetable matter may include oaten chaff or oaten hay, or mixtures thereof. The third portion may the same or different to the second portion of vegetable matter. In some cases, the third portion of vegetable matter may also be a chaff or a hay, or a mixture thereof. For instance, the third portion of vegetable matter may include lucerne chaff or lucerne hay, or mixtures thereof. The first period of time may be any length of time suitable for sufficiently blending the first portion of vegetable matter with the carbohydrate source. Such a time period is typically between 1 minute and 20 minutes, and even more typically between 5 minutes and 15 minutes. Likewise, the second period of time may be any length of time suitable for sufficiently blending the second portion of vegetable matter with the first portion of vegetable matter and carbohydrate source. Such a time period is typically between 1 minute and 20 minutes, and even more typically between 5 minutes and 15 minutes. The third period of time may be any length of time suitable for sufficiently blending the third portion of vegetable matter with the first and second portions of vegetable matter and carbohydrate source. Such a time period is typically between 1 minute and 20 minutes, and even more typically between 5 minutes and 15 minutes. The fourth period of time may be any length of time suitable for sufficiently blending the inorganic binding agent with the first, second and third portions of vegetable matter and the carbohydrate source. Such a time period is typically between 1 minute and 20 minutes, and even more typically between 5 minutes and 15 minutes.

Again, when the vegetable matter is added in stages the process of mixing may result in a reduction in the particle size of the vegetable matter relative to the particle size before the mixing process. This is particularly relevant when the vegetable matter is chaff or hay. The reduction in size can be controlled by variation of factors such as the mixing speed, mixing time and relative proportions of various ingredients. Typically the final particle size achieved by the process of mixing is between 1 and 200 mm.

The carbohydrate source suitable for use in the process of the invention is typically added in a proportion of 1-60 wt %. In particular cases, the carbohydrate source may be present in the composition a proportion of 5-20 wt %. In some cases the carbohydrate source is added such that the proportion of carbohydrate source is 7 to 15 wt %. The carbohydrate source is typically a carbohydrate syrup such as corn syrup, glucose syrup, sugar syrup, golden syrup, treacle or molasses, or a mixture thereof. In particular embodiments of the invention molasses is used as the carbohydrate source in the processes of the invention.

Inorganic binding agents suitable for use with the processes of the invention may be any inorganic binding agent which, when combined with the vegetable matter and carbohydrate source will provide a suitably firm composition. The inorganic binding agent will typically be non-toxic to the animals to be fed. The inorganic binding agent will typically be a compound of an alkali earth metal such as barium, calcium, magnesium or strontium. More preferably, the inorganic binding agent will be a compound of calcium or magnesium, and most preferably a compound of calcium. Inorganic binding agents which may be suitable for use with the invention include gypsum, calcium silicate, calcium sulfate, hydrated lime, talc, dolomite, serpentine or magnesium hydroxide. The inorganic binding agent is typically present in an amount of from 1-20 wt %, more typically from 1-10%. In some cases the inorganic binding agent is present in an amount of from 1-5 wt %. The amount of inorganic binding agent can be varied depending on the particular inorganic binding agent added and the desired properties of the composition. A particularly favored inorganic binding agent is hydrated lime. A particularly favoured amount of hydrated lime is 1-20 wt %. In some other embodiments the amount of hydrated lime added is 1-10 wt %. In still other embodiments, the amount of hydrated lime added is 1-5 wt %.

Additional materials may also be added during the processes of the invention. The particular additional materials added will be determined by the particular animals to be fed with the composition, and in particular the nutritional and dietary requirements of those animals. The additional materials may be added at any point during the process. The additional materials may be added at the same time as the carbohydrate source, the vegetable matter or the inorganic binding agent. When the vegetable matter is added in one, two, or three portions, additives may be included with one or more of the portions. In some cases it may be beneficial to add the additional materials directly to the carbohydrate source before the vegetable matter is added. In other cases the additional materials may be added a separate time altogether from the main components. The materials added may be incorporated as vitamins, minerals, preservatives, supplements or flavourings. Examples of possible additives include protein meals such as Protexin, feed grade oils such as vegetable, sunflower or canola oil, trace element, vitamin or mineral products such as zeolite, V&M, magnesium hydroxide or kiln dried fine salt. In some cases the additives may be by-products from the production of human or animal foodstuffs. In other cases the additives may be custom made veterinary products known to those having skill in the art.

The process of the invention may be conducted at any temperature. Typically, the processes of the invention will be performed at ambient temperature, though the processes of the invention are suitable for carrying out at any temperature between −20 and 120° C. In some cases it may be beneficial from a handling perspective to elevate the temperature of the molasses prior to adding to the mixer so as to ensure optimum flow and ease of mixing.

Examples of the compositions and processes of the present invention will now be provided. In providing these examples, it is to be understood that the specific nature of the following description is not to limit the generality of the above description.

### EXAMPLES

### Example 1

| Ingredient | Mass (kg) | Wt % |
|---|---|---|
| Lucerne chaff/hay | 365 | 36.5 |
| Oaten chaff/hay | 365 | 36.5 |
| Feed oats | 100 | 10.0 |
| Molasses | 125 | 12.5 |
| V&M | 2.5 | 0.25 |
| Protexin | 1 | 0.1 |
| Zeolite | 10 | 1.0 |
| Kiln dried fine salt | 10 | 1.0 |
| Hydrated lime | 20 | 2.0 |
| Total | 998.5 | |

The molasses and feed oats are added to a mixer and mixed until well blended. The oaten chaff is then added and allowed to mix for five minutes with the molasses and feed oats prior to the addition of lucerne chaff. Mixing proceeds for a further 10 minutes after the addition of the lucerne chaff, during which time the chaff is cut down to a maximum size of 1-2 inches. The hydrated lime and other additives (V&M, Protexin, kiln dried fine salt, and zeolites) are then added and mixed for a further 10-15 minutes.

The mixture is then charged into a press and a pressure of 25-500 tonne is applied to form a compressed feed block composition of the invention.

### Example 2

| Ingredient | Mass (kg) | Wt % |
|---|---|---|
| Lucerne chaff/hay | 200 | 36.5 |
| Oaten chaff/hay | 200 | 36.5 |
| Feed oats | 100 | 10.0 |
| Molasses | 50 | 12.5 |
| Hydrated lime | 10 | 2.0 |
| Total | 560 | |

The molasses and feed oats are added to a mixer and mixed until well blended. The oaten chaff is then added and allowed to mix for five minutes with the molasses and feed oats prior to the addition of lucerne chaff. Mixing proceeds for a further 10 minutes after the addition of the lucerne chaff, during which time the chaff is cut down to a maximum size of 1-2 inches. The hydrated lime is then added and mixed for a further 10-15 minutes.

The mixture is then charged into a press and a pressure of 25-500 tonne is applied to form a compressed feed block composition of the invention.

### Example 3

| Ingredient | Mass (kg) | Wt % |
|---|---|---|
| Lucerne chaff/hay | 100 | 21.6 |
| Oaten chaff/hay | 100 | 21.6 |
| Feed oats | 50 | 10.8 |
| Molasses | 50 | 10.8 |
| Hydrated lime | 12 | 2.6 |
| Black sunflower seeds | 25 | 5.4 |
| Crushed maize | 25 | 5.4 |
| Crushed lupins | 25 | 5.4 |
| Crushed Tic beans | 25 | 5.4 |
| S/R barley | 50 | 10.8 |
| V&M | 1.3 | 0.3 |
| Protexin | 0.5 | 0.1 |
| Total | 463.8 | |

The molasses and grains (feed oats, black sunflower seeds, crushed maize, crushed lupins, crushed tic beans and S/R barley) are added to a mixer and mixed until well blended. The oaten chaff is then added and allowed to mix for five minutes with the molasses and grains prior to the addition of lucerne chaff. Mixing proceeds for a further 10 minutes after the addition of the lucerne chaff, during which time the chaff is cut down to a maximum size of 1-2 inches. The hydrated lime and other additives (V&M, Protexin) are then added and mixed for a further 10-15 minutes.

The mixture is then charged into a press and a pressure of 25-500 tonne is applied to form a compressed feed block composition of the invention.

### Example 4

| Ingredient | Mass (kg) | Wt % |
|---|---|---|
| Lucerne chaff/hay | 200 | 85.9 |
| Molasses | 25 | 10.7 |
| Hydrated lime | 7 | 3.0 |
| V&M | 0.6 | 0.3 |
| Protexin | 0.2 | 0.1 |
| Total | 232.8 | |

The molasses is added to a mixer followed by the addition of lucerne chaff. Mixing proceeds for 10 minutes at 20 to 25 rpm after the addition of the lucerne chaff, during which time the chaff is cut down to a maximum size of 1-2 inches. The hydrated lime and other additives (V&M, Protexin) are then added and mixed for a further 10-15 minutes.

The mixture is then charged into a press and a pressure of 25-500 tonne is applied to form a compressed feed block composition of the invention.

### Example 5

| Ingredient | Mass (kg) | Wt % |
|---|---|---|
| Lucerne chaff/hay | 200 | 35.6 |
| Oaten chaff/hay | 200 | 35.6 |
| Feed oats | 100 | 17.8 |
| Molasses | 50 | 8.9 |
| Hydrated lime | 12 | 2.1 |
| Total | 562 | |

The molasses and feed oats are added to a mixer and mixed until well blended. The oaten chaff is then added and allowed to mix for five minutes with the molasses and feed oats prior to the addition of lucerne chaff. Mixing proceeds for a further 10 minutes after the addition of the lucerne chaff, during which time the chaff is cut down to a maximum size of 1-2 inches. The hydrated lime is then added and mixed for a further 10-15 minutes.

The mixture is then charged into a press and a pressure of 25-500 tonne is applied to form a compressed feed block composition of the invention.

### Example 6

| Ingredient | Mass (kg) | Wt % |
|---|---|---|
| Lucerne chaff/hay | 400 | 35.4 |
| Oaten chaff/hay | 400 | 35.4 |
| Feed oats | 200 | 17.7 |
| Molasses | 100 | 8.8 |
| Hydrated lime | 24 | 2.1 |
| V&M | 2.5 | 0.2 |
| Protexin | 1 | 0.05 |
| Dichlorvos | 10 (ml) | — |
| Total | 1127.5 | |

The molasses and feed oats are added to a mixer and mixed until well blended. The oaten chaff is then added and allowed to mix for five minutes with the molasses and feed oats prior to the addition of lucerne chaff. Mixing proceeds for a further 10 minutes after the addition of the lucerne chaff, during which time the chaff is cut down to a maximum size of 1-2 inches. The hydrated lime and other additives (V&M, Protexin, Dichlorvos) are then added and mixed for a further 10-15 minutes.

The mixture is then charged into a press and a pressure of 25-500 tonne is applied to form a compressed feed block composition of the invention.

### Example 7

| Ingredient | Mass (kg) | Wt % |
|---|---|---|
| Lucerne chaff/hay | 516.6 | 45.8 |
| Oaten chaff/hay | 258.3 | 22.9 |
| Feed oats | 225 | 20.0 |
| Molasses | 100 | 8.9 |
| Hydrated lime | 24 | 2.1 |
| V&M | 2.5 | 0.2 |
| Protexin | 1 | 0.05 |
| Total | 1127.4 | |

The molasses and feed oats are added to a mixer and mixed until well blended. The oaten chaff is then added and allowed to mix for five minutes with the molasses and feed oats prior to the addition of lucerne chaff. Mixing proceeds for a further 10 minutes after the addition of the lucerne chaff, during which time the chaff is cut down to a maximum size of 1-2 inches. The hydrated lime and other additives (V&M, Protexin, Dichlorvos) are then added and mixed for a further 10-15 minutes.

The mixture is then charged into a press and a pressure of 25-500 tonne is applied to form a compressed feed block composition of the invention.

### Example 8

| Ingredient | Mass (kg) | Wt % |
|---|---|---|
| Lucerne chaff/hay | 846 | 86.9 |
| Molasses | 100 | 10.3 |
| Hydrated lime | 24 | 2.5 |
| V&M | 2.5 | 0.3 |
| Protexin | 1 | 0.1 |
| Total | 973.5 | |

The molasses is added to a mixer followed by the addition of lucerne chaff. Mixing proceeds for 10 minutes at 20 to 25 rpm after the addition of the lucerne chaff, during which time the chaff is cut down to a maximum size of 1-2 inches. The hydrated lime and other additives (V&M, Protexin) are then added and mixed for a further 10-15 minutes.

The mixture is then charged into a press and a pressure of 25-500 tonne is applied to form a compressed feed block composition of the invention.

### Example 9

| Ingredient | Mass (kg) | Wt % |
|---|---|---|
| Lucerne chaff/hay | 300 | 21.6 |
| Oaten chaff/hay | 300 | 21.6 |
| Feed oats | 150 | 10.8 |
| Molasses | 50 | 10.8 |
| Hydrated lime | 36 | 2.6 |
| Black sunflower seeds | 75 | 5.4 |
| Crushed maize | 75 | 5.4 |
| Crushed lupins | 75 | 5.4 |
| Crushed Tic beans | 75 | 5.4 |
| Whole barley | 150 | 10.8 |
| V&M | 3.5 | 0.3 |
| Protexin | 1.4 | 0.1 |
| Total | 1390.9 | |

The molasses and grains (feed oats, black sunflower seeds, crushed maize, crushed lupins, crushed tic beans and whole barley) are added to a mixer and mixed until well blended. The oaten chaff is then added and allowed to mix for five minutes with the molasses and grains prior to the addition of lucerne chaff. Mixing proceeds for a further 10 minutes after the addition of the lucerne chaff, during which time the chaff is cut down to a maximum size of 1-2 inches. The hydrated lime and other additives (V&M, Protexin) are then added and mixed for a further 10-15 minutes.

The mixture is then charged into a press and a pressure of 25-500 tonne is applied to form a compressed feed block composition of the invention.

Finally, it will be appreciated that various modifications and variations of the methods and compositions of the invention described herein will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are apparent to those skilled in the art are intended to be within the scope of the present invention.

1. An animal feed composition including:
(a) 30-98 wt % of vegetable matter;
(b) 1-60 wt % of a carbohydrate source; and
(c) 1-20 wt % of an inorganic binding agent.

2. An animal feed composition according to claim 1, wherein the carbohydrate source is molasses.

3. An animal feed composition according to claim 1 or claim 2, wherein the inorganic binding agent is hydrated lime.

4. An animal feed composition according to any one of claims 1 to 3 claim 1, wherein the animal feed composition is in a compressed form.

5. (canceled)

6. An animal feed composition according to any one of claims 1 to 5 claim 1, wherein the vegetable matter is selected from the group consisting of chaff, grains, hays, cereals, straws, legumes, and mixtures thereof.

7-11. (canceled)

12. An animal feed composition according to any one of claims 1 to 11 claim 1, wherein the composition includes 1-5 wt % inorganic binding agent.

13. (canceled)

14. An animal feed composition any one of claims 1 to 13 claim 1, wherein the composition includes 7 to 15 wt % carbohydrate source.

15. An animal feed composition any one of claims 1 to 11 claim 1, wherein the composition includes 75 to 94 wt % vegetable matter.

16. (canceled)

17. A process for preparing a compressed block animal feed composition including:
providing vegetable matter, a carbohydrate source and an inorganic binding agent;
mixing the vegetable matter, carbohydrate source and inorganic binding agent to provide a mixture thereof; and
applying pressure to the mixture to form a compressed block of the mixture.

18. (canceled)

19. A process according to claim 17 or claim 18, wherein mixing the vegetable matter, carbohydrate source and inorganic binding agent includes:
adding the vegetable matter to the carbohydrate source and mixing for a first period of time;
adding the inorganic binding agent to the vegetable matter and carbohydrate source and mixing for a second period of time.

20. A process according to claim 19 claim 17, wherein the vegetable matter is selected from the group consisting of chaff, grains, hays, cereals, straws, legumes, and mixtures thereof.

21. (canceled)

22. A process according to any one of cl claim 19, wherein the first period of time is between 1 minute and 20 minutes.

23. (canceled)

24. A process according to claim 19, wherein the second period of time is between 1 minute and 20 minutes.

25. (canceled)

26. A process according to claim 17 or claim 18, wherein mixing the vegetable matter, carbohydrate source and inorganic binding agent includes:
adding a first portion of the vegetable matter to the carbohydrate source and mixing for a first period of time;
adding a second portion of the vegetable matter to the first portion of vegetable matter and the carbohydrate source and mixing for a second period of time;
adding the inorganic binding agent to the first and second portions of vegetable matter and carbohydrate source and mixing for a third period of time.

27-30. (canceled)

31. A process according to claim 26, wherein the first period of time is between 1 minute and 20 minutes.

32. (canceled)

33. A process according to claim 26, wherein the second period of time is between 1 minute and 20 minutes.

34. (canceled)

35. A process according to claim 26, wherein the third period of time is between 1 minute and 20 minutes.

36-37. (canceled)

38. A process according to claim 17, wherein mixing the vegetable matter, carbohydrate source and inorganic binding agent includes:
adding a first portion of the vegetable matter to the carbohydrate source and mixing for a first period of time;
adding a second portion of the vegetable matter to the first portion of vegetable matter and the carbohydrate source and mixing for a second period of time;
adding a third portion of the vegetable matter to the first and second portions of vegetable matter and the carbohydrate source and mixing for a third period of time;
adding the inorganic binding agent to the first, second and third portions of vegetable matter and carbohydrate source and mixing for a fourth period of time.

39-44. (canceled)

45. A process according to claim 38, wherein the first period of time is between 1 minute and 20 minutes.

46. (canceled)

47. A process according to claim 38, wherein the second period of time is between 1 minute and 20 minutes.

48. (canceled)

49. A process according to claim 38, wherein the third period of time is between 1 minute and 20 minutes.

50. (canceled)

51. A process according to claim 38, wherein the fourth period of time is between 1 minute and 20 minutes.

52-53. (canceled)

54. A process according to claim 17, wherein the carbohydrate source is molasses.

55. A process according to claim 17, wherein the inorganic binding agent is hydrated lime.

56-62. (canceled)
